(19) United States
(12) Patent Application Publication
(10) Pub. No.: US 2026/0198537 A1
(43) Pub. Date: Jul. 16, 2026

(54) FOOD COLOURANT REPLACER COMPOSITION, FOOD COMPOSITION COMPRISING IT AND METHOD OF PREPARATION THEREOF

(71) Applicant: Cargill, Incorporated, Wayzata, MN (US)

(72) Inventors: Melissa Ann Machen, Union, MO (US); Scott Alan Woodward, Brooklyn Park, MN (US)

(73) Assignee: Cargill, Incorporated, Wayzata, MN (US)

(21) Appl. No.: 19/135,592

(22) PCT Filed: Dec. 11, 2023
(86) PCT No.: PCT/US2023/083305

§ 371 Date: Jun. 4, 2025

Related U.S. Application Data
(60) Provisional application No. 63/387,988, filed on Dec. 19, 2022.

(51) Int. Cl. A23L 5/43; A23L 5/42

(52) U.S. Cl. CPC A23L 5/43; A23L 5/42

(57) ABSTRACT

The present disclosure provides a food colorant replacer composition. The food replacer composition can include from 0.5 wt. % to 2.5 wt. % modified food starch obtained by n-octenyl succinic anhydride esterification of starch isolated from waxy maize; from 0.10 wt. % to 2.0 wt. % soluble rice flour obtained by enzymatic treatment of rice flour; and from 0.10 wt. % to 0.76 wt % calcium carbonate. In various aspects, the food replacer composition can impart a whitening effect to a food product. Other aspects are also provided herein.

### CROSS-REFERENCE TO RELATED APPLICATIONS

This application claims the benefit of U.S. Provisional Application No. 63/387,988, filed Dec. 19, 2022, which is incorporated by reference herein in its entirety.

### FIELD OF THE INVENTION

The present disclosure relates to a food colorant replacer composition and methods of making and using the food colorant replacer composition. In particular, the present disclosure relates to a food colorant replacer composition containing a mixture of modified food starch, soluble rice flour, and calcium carbonate that can impart color to a food-grade product.

### BACKGROUND

Titanium dioxide is a fine white powder commonly used to color food-grade products, including confections, soups, fillings, egg-based products, and more. Titanium dioxide is an excellent choice for providing a whitening effect to food products because it is stable under various temperatures, light conditions, pH levels, and moisture levels. The titanium dioxide present in a food can scatter light to alter the appearance of the food and to provide a white cast to the food product. To provide the whitening effect to various food products, titanium dioxide particles need to be approximately from 200 to 300 nanometers (nm) in diameter. Particles of titanium dioxide in the 200 nm to 300 nm range are not considered to be nanoparticles. While most powdered titanium dioxide used in foods is not considered to be on the nanometer scale, the production process can produce particles in the nanoparticle range (i.e., any particles up to 100 nm). Nanoparticles of titanium dioxide may contribute to certain adverse health conditions if inhaled or ingested during manufacture or consumption.

While titanium dioxide has been deemed safe by the United States Food and Drug Administration when used as an ingredient at up to 1% of the weight of the final product, various entities have questioned the use of titanium dioxide in foods due to the nanoparticles being implicated in health conditions, including cancer, diabetes, cardiovascular disease, gastrointestinal disease, and more. Further, the European Food Safety Authority (EFSA) has recently deemed titanium dioxide to be unsafe as a food additive and has effectively banned its use in foodstuffs altogether. As an alternative, the compound calcium carbonate has been used as a whitening agent in various types of foods, including confections, drugs, pet foods, dairy products, and condiments, however, its use is restricted in scope to various foods and it requires strict adherence to good manufacturing practice for each food type. Further, the amount of calcium carbonate required to obtain food colorant properties similar to that of titanium dioxide is not a direct one-to-one substitution. For example, if used as a food colorant replacer in egg white products, the amount of calcium carbonate required would be about ten times the level allowed for calcium fortification in such food products. Thus, a direct substitution of titanium dioxide with calcium carbonate alone is not straightforward and runs counter to regulatory restrictions. Additionally, recent heightened awareness about the health implications around the use of titanium dioxide and the limitations on calcium carbonate use as a viable one-to-one substitute has placed a demand on the market to shift to alternative colorant replacers.

### SUMMARY

The present disclosure provides a food colorant replacer composition. The food replacer composition can include from 0.5 wt. % to 2.5 wt. % modified food starch obtained by n-octenyl succinic anhydride esterification of starch isolated from waxy maize; from 0.10 wt. % to 2.0 wt. % soluble rice flour obtained by enzymatic treatment of rice flour; and from 0.10 wt. % to 0.76 wt. % calcium carbonate.

In various aspects, the modified food starch has i.) hydrophilic and lipophilic properties; ii.) a pH of from 5.0 to 7.0 when mixed as a 20% w/w aqueous solution; and iii.) a moisture content of from 10.5% to 12.5%. In various aspects, the modified food starch has not been subjected to a thinning process. In various aspects, the modified food starch is a granular starch.

In various aspects, the soluble rice flour has not been subjected to a further enzymatic reaction or a filtering process. In various aspects, the soluble rice flour includes i.) a dextrose equivalent of from 8 to 15; ii.) a solubility greater than 50% at 5% solids; and iii.) a viscosity 1 centipoise to 1000 centipoise at temperatures ranging from 20° C. to 50° C. at 10% solids. In various aspects, the soluble rice flour includes a soluble component that is from about 80-95 wt. % soluble in water; and an insoluble component from about 0-20 wt. % and that imparts at least a portion of a whitening effect by the food colorant replacer composition. The rice flour does not confer an increase in viscosity to the food colorant replacer composition.

In various aspects, the calcium carbonate is present at from 0.10 to 0.15 wt. %.

In various aspects, the food colorant replacer composition includes a colloidal dispersion.

In various aspects, the food colorant replacer composition has an L value or imparts an L value in a food product that is from 75 to 90.

In various aspects, the food colorant replacer composition is powder composition or an aqueous suspension.

The present disclosure further includes a food product including a food colorant replacer composition. The food product disclosed herein can include an egg substitute product. The food product disclosed herein can be free of titanium dioxide.

The present disclosure provides a method for producing a food colorant replacer composition for use in food-grade products. The method can include producing a food colorant replacer composition following the steps including (a) providing a modified food starch, wherein the modified food starch is obtained by n-octenyl succinic anhydride esterification of starch isolated from waxy maize; (b) providing a soluble rice flour, wherein the soluble rice flour is obtained by enzymatic treatment of rice flour and is not subjected to any additional filtering or purification processes; (c) providing calcium carbonate; and (d) mixing the modified food starch, the soluble rice flour, and the calcium carbonate to form the food colorant replacer composition. The food colorant replacer composition produced using the methods herein is suitable for use in the food-grade products to impart a whitening effect at concentrations including from 0.50 wt. % to 2.5 wt. % of the modified food starch; from 0.10 wt. % to 2.0 wt. % of the soluble rice flour; and from 0.10 wt. % to 0.76 wt. % of calcium carbonate.

The methods herein further can include where the modified food starch includes i.) hydrophilic and lipophilic properties; ii.) a pH of from 5.0 to 7.0 when mixed as a 20% w/w aqueous solution; and iii.) a moisture content of from 10.5% to 12.5%.

The methods herein further can include where the modified food starch has not been subjected to a thinning process. The methods herein further can include where the modified food starch includes a granular starch.

The methods herein further can include where the soluble rice flour includes i.) a dextrose equivalent of from 8 to 15; ii.) a solubility greater than 50% at 5% solids; and iii.) a viscosity 1 centipoise to 1000 centipoise at temperatures ranging from 20° C. to 50° C. at 10% solids. The methods herein further can include where the soluble rice flour includes a soluble component that is from about 80-95 wt. % soluble in water; and an insoluble component from about 0-20 wt. % and that imparts at least a portion of a whitening effect by the food colorant replacer composition. The rice flour does not confer an increase in viscosity to the food colorant replacer composition.

The methods herein further can include where the concentration of the modified food starch includes from 1.0 wt. % to 2.5 wt. %, the concentration of soluble rice flour includes from 0.10 wt. % to 0.50 wt. %, and the concentration of calcium carbonate includes from 0.10 wt. % to 0.15 wt. %.

The methods herein further can include analyzing L, a, and b color values of the food colorant replacer composition; and modifying one or more concentrations of the modified food starch, the soluble rice flour, or the calcium carbonate to adjust one or more of the L, a, or b color values to within predetermined values.

The methods herein further can include where increasing or decreasing one or more concentrations of the modified food starch, the soluble rice flour, or the calcium carbonate in the food colorant replacer composition adjusts the L value to fall within a range of from 75 to 90.

### BRIEF DESCRIPTION OF THE DRAWINGS

The drawings illustrate generally, by way of example, but not by way of limitation, various aspects discussed herein.

FIG. 1 is a graphical representation of food product composition colorimetry data as a function of ingredient concentration in accordance with various aspects herein.

FIG. 2 is a graphical representation of food product composition colorimetry data as a function of ingredient concentration in accordance with various aspects herein.

FIG. 3 is a graphical representation of food product composition colorimetry data as a function of ingredient concentration in accordance with various aspects herein.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

As described above, there is an industry-wide need for titanium-free alternatives to use as to provide a whitening effect to various foods. Efforts to rely on compounds such as calcium carbonate alone have proven insufficient due to the high concentrations of calcium carbonate required to achieve a desired level of whitening effect in food products, which often exceed regulatory requirements. The use of calcium carbonate to achieve effective whitening in some foodstuffs can require amounts that often exceed allowable limits as set forth at least in the U.S. by 21 C.F.R § 104.20 (e), which states, “[a]nutrient(s) may appropriately be added to a food that replaces traditional food in the diet to avoid nutritional inferiority in accordance with § 101.3 (e)(2) of this chapter,” and further by 21 C.F.R § 130.10 (b)(1), which states, “[n]utrients shall be added to the food to restore nutrient levels so that the product is not nutritionally inferior, as defined in § 101.3(e)(4) of this chapter, [ . . . ].” Further, it has been established that the use of calcium carbonate above certain levels can have adverse effects on the organoleptic properties, such as the taste and texture, of the food. It has been surprisingly discovered herein that a composition including modified food starch, soluble rice flour, and calcium carbonate creates a food colorant replacer composition with whitening properties equivalent to those utilizing titanium dioxide according to the industry standard. The present disclosure provides food colorant replacer compositions and methods for formulating food colorant replacer compositions. In various aspects, the food colorant replacer compositions herein are suitable for imparting a whitening effect to egg substitute products. In various aspects, the egg substitute products can include egg white products.

### Food Colorant Replacer Compositions

The present disclosure provides for food colorant replacer compositions for use in food-grade products that impart a whitening effect to the food-grade products, and methods for creating food colorant replacer compositions. The food colorant replacer compositions herein unexpectedly provide a composition that has desirable properties for imparting a whitening effect to various food products without adverse effects on the organoleptic properties of the food products and with no known adverse health effects. Alone, each of the ingredients of the food colorant replacer compositions herein fails to impart the desired color and organoleptic properties to the food product. When combined together, the ingredients of the food colorant replacer compositions collectively contribute to the overall whitening effect on the food-grade product. The food colorant replacer compositions herein include various concentrations of modified food starches, soluble rice flour, and calcium carbonate, that when combined in a mixture create a food colorant replacer composition that imparts a whitening effect to a food product. It will be appreciated that the food colorant compositions herein do not contain titanium dioxide. As used herein, the terms “food-grade product” and “food product” can be used interchangeably unless otherwise noted.

Without wishing to be bound by any particular theory, it is believed that the food colorant replacer compositions herein form a colloidal dispersion. The colloidal dispersion can be formed within the liquid food-grade products that the food colorant replacer compositions are incorporated into. The colloidal dispersion can reduce any amount of yellowness present in a food-grade product by increasing opacity to the product, and further can impart a white appearance to the solution. It should be noted that the food colorant replacer composition itself is not a food dye, food colorant, or whitening agent itself, but rather it is the properties of the colloidal dispersion that scatters light such that the final product appears white in color without adding any additional color to the product.

### Starches

It will be appreciated that starches are carbohydrate polymers formed by the polymerization of glucose monomers. Various plants store starch granules in their seeds for future energy use requirements. Additionally, some plants store starch granules in tubers, roots, and the like. In general, starch granules are particles on the order of from one micron to 100 microns in size and are composed of two major types of glucose polymers. The two types of glucose polymers include amylose, a linear starch polymer, and amylopectin, a highly branched starch polymer. Many crops, including oat, barley, maize, wheat, and potatoes are harvested for nutritional value they can impart to various foods. The vast majority of corn grown and processed is yellow dent corn, but other important hybrids are waxy corn, and high-amylose corn. These varieties differ from yellow dent corn in the ratio of amylose to amylopectin polymer ratio in the starch granule.

In harvested maize or corn, up to 70% by weight of the kernel can be starch. Starch in its native form can be extracted from the corn kernel by either a dry milling or wet milling process. In wet milling of corn, the corn kernels are re-hydrated from approximately 14% storage moisture to 40% moisture by a process called steeping. Once the steeped corn is of the appropriate moisture, the softened kernel is conveyed through a series of grind mills to remove the components such as the germ, the fiber outer layer, the corn protein (zein), and finally the purified starch. In some aspects, such as in a low solids slurry stream, the starch slurry can be further purified to a concentrated slurry of approximately 40% solids, where % solids is equivalent to wt. %. The purified starch granules can be used in this form in many food and industrial applications.

In various aspects, modifications can be made to native starch granules in order to enhance or change their physicochemical properties. Various modification techniques are known to alter the physicochemical properties of starches, including various types of physical modification, enzymatic modification, or chemical modification. In an aspect, a chemical modification of starch can include a process called dextrinization. Starch in a dry form can be introduced into a dextrin reactor and heated to a high temperature, generally from 100° C. and 150° C., in combination with a catalytic amount of acid. The dry reaction causes polymer rearrangement and changes the viscosity and physiochemical properties of the material. Some dextrins can be modified to the point where they become cold water soluble. In other aspects, starches can be physically modified to become “instant” in nature after undergoing a cooking process at high temperature and/or pressure to facilitate swelling and viscosity development in cold water. It will be appreciated that some of the starches herein include starches that have been modified by esterification reaction with n-octenyl succinic anhydride (i.e., a nOSA starch). In various aspects, the processing of the starches suitable for use herein can result in starches that have an insoluble component that can contribute to the white appearance imparted by a food colorant replacer composition.

Exemplary modified food starches for use in the food colorant replacer compositions herein can include various starch sodium octenyl succinates such as EmCap™ 12633, EmCap™ 06376, and EmTex™ 06379 (Cargill Inc.; Wayzata, MN, USA). The starch sodium octenyl succinates are modified food starches obtained by the esterification of waxy maize with n-octenyl succinic anhydride. Each of EmCap™ 12633, EmCap™ 06376, and EmTex™ 06379 have unique physicochemical profiles as outlined herein.

EmCap™ 12633 is a stabilized modified food starch that is characterized as a starch sodium octenyl succinate derived from waxy maize that has been instantized and thinned. EmCap™ 12633 is an enzyme converted starch that has been cooked under high temperature and pressure to become pre-gelatinized and is highly soluble in cold water. EmCap™ 12633 has a white to yellow solid color. EmCap™ 12633 is a solid powder possessing up to 10% moisture. The pH of EmCap™ 12633 is from 3.5 to 4.5 when 25 g is mixed as a slurry in 100 ml of water. The viscosity of EmCap™ 12633 in a prepared aqueous paste at 25% dry solids is 450 centipoise (cP) to 1100 cP when measured at 25° C. and 250 rotations per minute (RPM) in a Rapid Visco Analyzer (RVA). Additional properties of EmCap™ 12633 include encapsulating properties, low viscosity, substantial cloud formation in solution, easy dispersibility in a mixture, and high oxidation resistance.

EmCap™ 06376 is a modified food starch that is characterized as a starch sodium octenyl succinate derived from waxy maize that has been dextrinized. EmCap™ 06376 is a lipophilic starch possessing properties consistent with oxidation reduction. EmCap™ 06376 is characterized as a white to off white solid powder with no odor and at most 6% moisture content in the powdered form. The pH of EmCap™ 06376 is from 2.4 to 8.0 when 20 g is mixed as a slurry in 100 ml of water. EmCap™ 06376 is 90% to 100% soluble in water when measured at 25° C.

EmTex™ 06379 is a modified food starch that is obtained by esterification of waxy maize with n-octenyl succinic anhydride, resulting in a modified food starch having both hydrophilic and lipophilic properties. EmTex™ 06379 is characterized as a granular white to off white solid powder with no odor. EmTex™ has not been thinned by any type of modification step. The pH of EmTex™ 06379 is from 5.0 to 7.0 when 20 g is mixed as a slurry in 100 ml of water. Additional properties of EmTex™ 06379 include that it promotes viscosity and emulsion development and it is easily dispersible in a mixture.

The concentration of the modified food starch in the food colorant replacer composition contributes to the whitening effect imparted to various food products. The concentration of modified food starch suitable for use in the food colorant replacer compositions herein includes from 0.50 wt. % to 2.5 wt. % of the modified food starch in the food product. In some aspects, the concentration of modified food starch suitable for use in the food colorant replacer compositions herein includes from 1.0 wt. % to 2.5 wt. %. In various aspects, the concentration of modified food starch suitable for use in the food colorant replacer compositions herein includes from 0.50 wt. %, 0.60 wt. %, 0.70 wt. %, 0.80 wt. %, 0.90 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2.0 wt. %, 2.1 wt. %, 2.2 wt. %, 2.3 wt. %, 2.4 wt. %, or 2.5 wt. %, or a range within any of the forgoing.

### Soluble Rice Flour

Soluble rice flour can be obtained by using any know genus or species of rice commonly used in food products. As used herein, “soluble,” in the context of “soluble rice flour,” can refer to hydrolyzed, enzymatically treated, enzymatically modified, and soluble flours. The soluble rice flour suitable for use herein can include those that have an insoluble component that can contribute to a whitening effect imparted by a food colorant replacer composition. The soluble rice flour suitable for use herein can be formed following a process as described in co-owned U.S. Pat. Application No. 2021/0112833A1, which is hereby incorporated by reference in its entirety.

In brief, soluble rice flour can be formed by preparing a slurry of rice flour that includes anywhere from 15 wt. % to 40 wt. % flour in water. The rice flour slurry can be pH adjusted to within a range of from 3.5 to 6.0, within a range of 4.5 to 5.5, or further within a range of 4.7 to 5.3, or even further within a range of from 4.8 to 5.2. Various acids can be used to adjust the pH, such as for example, hydrochloric acid. In various aspects, the rice flour slurry can be subject to enzymatic degradation with a thermal stable alpha amylase or other suitable enzyme, including, but not to be limited to isoamylase, glucoamylase, beta amylase, pullulanase, or other amylolytic enzymes, or combinations thereof. The enzymatic degradation can be performed using from 0.02 wt. % to 2.0 wt. %, enzyme relative to the weight of the flour, or any value within the forgoing range, at from 50° C. to 95° C. The pH adjusted rice flour slurry and added enzyme can be subjected to a jet cooker process, where the mixture of rice flour slurry and enzyme can be added to a jet cooker at a cooking temperature from 110° C. to 150° C., or from 110° C. to 117° C., and an outlet temperature of 95° C. to 150° C. Once the mixture exits the jet cooker, the reaction can be allowed to proceed until completion and a dextrose equivalent (DE) of from 5 and 18 is achieved. Without wishing to be limited to any particular theory, it is to be understood that a dextrose equivalent is a measure of the degree of hydrolysis of the rice flour into one or more reducing sugars present in the product as a percentage on a dry weight basis. Once the desired dextrose equivalent is reached, the mixture can be subjected to enzymatic heat inactivation step at pH 2.7-3.0, 95° C., for 15 minutes to deactivate the enzyme. Following heat inactivation, the resulting hot liquefact can be subject to one or more drying steps at from 100° C. to 200° C. to yield a soluble rice flour that contains about 95% dry solids.

Exemplary soluble rice flour includes an enzyme treated soluble rice flour such as SimPure™ RF 92260 (Cargill Inc.; Wayzata, MN, USA). SimPure™ RF 92260 is a soluble rice flour obtained by enzymatic treatment of rice flour. SimPure™ RF 92260 is characterized in that it contributes to viscosity, has similar hygroscopicity as other bulking agents such as maltodextrin, contributes to creamy mouthfeel, and contains an insoluble component. The pH of SimPure™ RF 92260 is from 4.0 to 7.0 when 50 g is mixed as a slurry in 100 ml of water. SimPure™ RF 92260 has about 10% moisture content in the powder form. In various aspects, the insoluble component of SimPure™ RF 92260 is capable of imparting a whitening effect to mixtures that contain it. In various aspects, the soluble rice flour suitable for use herein is not produced by utilizing a filtration step or purification step during processing. In various aspects, the rice flour suitable for use herein undergoes a single enzymatic degradation with alpha amylase, or another suitable enzyme as described elsewhere herein.

Suitable soluble rice flour compositions for use herein include those that have a solubility from 50% to 100% at 5% dry solids. In various aspects, the solubility of the soluble rice flour herein can have a solubility of from 75% to 85% at 5% dry solids. It will be appreciated that a range of insoluble materials within the soluble rice flours herein can be from 0% to 50% at 5% dry solids or from 0% to 25% at 5% dry solids. The soluble rice flour suitable for use herein has a viscosity of from 1 cP and 1000 cP at temperatures ranging from 20-50° C. at 10% solids. It will be appreciated that 10% solids is equivalent to a 10 wt. % soluble flour concentration. The soluble rice flour compositions herein further can include a protein content ranging from 0.01 to 15 wt. %, or from 0.50 wt. % to 15 wt. %. Suitable rice flours for use herein are further disclosed in co-owned U.S. Pat. Application Nos. 2021/0112833A1 and 2022/0000155A1, the contents of which are hereby incorporated by reference in their entirety.

The concentration of the soluble rice flour in the food colorant replacer composition contributes to the whitening effect imparted to various food products. The concentration of soluble rice flour suitable for use in the food colorant replacer compositions herein includes from 0.10 wt. % to 2.0 wt. % of the soluble rice flour in the food product. In some aspects, the concentration of soluble rice flour suitable for use in the food colorant replacer compositions herein includes from 0.10 wt. % to 0.50 wt. %. In various aspects, the concentration of soluble rice flour for use in the food colorant replacer compositions herein includes from 0.10 wt. %, 0.20 wt. %, 0.30 wt. %, 0.40 wt. %, 0.5 wt. %, 0.6 wt. %, 0.7 wt. %, 0.80 wt. %, 0.90 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, or 2.0 wt. %, or a range within any of the forgoing.

### Calcium Carbonate

Exemplary food-grade calcium carbonate (i.e., CaCO₃) sources include a line of Avalanche™ products, including Avalanche™ M and Avalanche™ M Ultra, which are proprietary calcium carbonate blends sourced from Sensient Technologies Corporation (St. Louis, MO, USA). Food-grade calcium carbonate can further be sourced from Omya Natural Calcium Carbonate sourced from Omya AG (Oftringen, Switzerland). While these two exemplary calcium carbonate forms are described, it will be appreciated that any suitable food-grade calcium carbonate composition can be utilized in the food colorant replacer compositions herein to contribute to the whitening effect and desirable organoleptic properties of a food product.

The concentration of the calcium carbonate in the food colorant replacer composition contributes to the whitening effect imparted to the foods. The concentration of calcium carbonate suitable for use in the food colorant replacer compositions herein includes from 0.10 wt. % to 0.76 wt. % of the calcium carbonate in the food product. In some aspects, the concentration of calcium carbonate suitable for use in the food colorant replacer compositions herein includes from 0.10 wt. % to 0.15 wt. %. In various aspects, the concentration of calcium carbonate for use in the food colorant replacer compositions herein includes from 0.10 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.20 wt. %, 0.25 wt. %, 0.30 wt. %, 0.35 wt. %, 0.40 wt. %, 0.45 wt. %, 0.50 wt. %, 0.55 wt. %, 0.60 wt. %, 0.65 wt. %, 0.70 wt. %, 0.75 wt. %, or 0.76 wt. %, or a range within any of the forgoing.

The present disclosure provides a food colorant replacer composition including from 0.5 wt. % to 2.5 wt. %, or from 1.0 wt. % to 2.5 wt. % modified food starch obtained by n-octenyl succinic anhydride esterification of starch isolated from waxy maize; from 0.10 wt. % to 2.0 wt. %, or from 0.10 wt. % to 0.50 wt. % soluble rice flour obtained by enzymatic treatment of rice flour; and from 0.10 wt. % to 0.76 wt. %, or from 0.10 to 0.15 wt. % calcium carbonate.

In various aspects, modified food starch of the food colorant replacer compositions herein include i.) both hydrophilic and lipophilic properties; ii.) a pH of from 5.0 to 7.0 when mixed as a 20% w/w aqueous solution; and iii.) a moisture content of from 10.5% to 12.5%. In various aspects, the modified food starch suitable for the food colorant replacer composition herein has not been subjected to a thinning process. In various aspects, the modified food starch comprises a granular starch.

In various aspects, the soluble rice flour has not been subjected to a further enzymatic reaction or a filtering process. In various aspects, the soluble rice flour suitable for use herein includes; i.) a dextrose equivalent of from 8 to 12; ii.) a solubility greater than 50% at 5% solids; and iii.) a viscosity from 1 centipoise to 1000 centipoise at temperatures ranging from 20° C. to 50° C. at 10% solids. In various aspects, the soluble rice flour herein can include a soluble component that is from about 80-95 wt. % soluble in water. In various aspects, the soluble rice flour can include a soluble component that is from 80 wt. %, 81 wt. %, 82 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, or 95 wt. %, or any amount within a range of the forgoing. In various aspects, the soluble rice flour herein can also include an insoluble component from about 0-20 wt. % and that imparts at least a portion of a whitening effect by the food colorant replacer. In various aspects, the soluble rice flour can include an insoluble component that is from 0 wt. %, 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, or 20 wt. %, or any amount within a range of the forgoing. The soluble rice flour can impart at least a portion of a whitening effect to the food colorant replacer. In various aspects, the rice flour does not confer an increase in viscosity to the food colorant replacer composition. The food colorant replacer compositions herein can include a powder composition or an aqueous suspension.

### Colorimetric Analysis

Colorimetric analysis of a material, including a solid composition or a liquid composition, can provide a level of color for the material. Without wishing to be bound to any particular theory, it is understood that the Hunter L, a, b scale and the CIE 1976 L*a*b CIELAB scales are based on the Opponent-Color Theory, which assumes that the receptors in the human eye perceive colors in pairs of opposites. The scales rely on measurements that include the L scale, the a scale, and the b scale. The L scale measures light versus ‘dark colors on a scale of from 0 to 100. For the L scale, a low number from 0 to 50 indicates a dark-colored material and a high number from 51-100 indicates a light-colored material. The a scale measures red versus green colors in a material. A positive number on the a scale indicates a material with a red color and a negative number on the a scale indicates a material with a green color. The b scale measures yellow versus blue colors in a material. A positive number on the b scale indicates a material with a yellow color and a negative number on the b scale indicates a material with a blue color.

When comparing materials, the L, a, and b values for a given material can be compared against a known standard material. The difference between a test material L, a, b values and a standard, or control material, L, a, b values can be reported as delta values and can be used to determine how much the test material is similar to or different than the control material. By way of example, the delta values can include ΔL, Δa, and Δb, and can each have a given tolerance when comparing a test material to a control material. The delta values can be used to adjust a food colorant replacer composition, as described herein, to be more like a control colorant composition by adjusting any of the disparate parameters. For example, if ΔL is out of tolerance the light or dark components of the composition may need to be adjusted accordingly. In another example, if Δa is positive, then the composition is too red and needs additional adjustment to align with the control. If Δa is negative, then the composition is too green and needs additional adjustment to align with the control. Similarly, if Δb is positive, then the composition is too yellow and needs additional adjustment to align with the control. If Δb is negative, then the composition is too blue and needs additional adjustment to align with the control.

The color of the food colorant replacer compositions or food products herein can be determined using a colorimeter. The colorimeter can be calibrated against a white tile background (Minolta Calibration Plate No. 17333022, Yxy Color Space: Y=93.4, x=0.3138, y=0.3201; Minolta Co., Ltd., Osaka, Japan). During operation, the colorimeter emits a beam of white light toward a material and a score for the L, a, and b scales is reported using the light that it reflected back to the instrument. Each unknown food colorant replacer composition or food product can be assayed for L, a, and b values by placing the colorimeter within the composition and recording the values. Without wishing to be bound by any particular theory, it is understood that L is a measure of lightness or darkness. A score from 51-100 indicates lightness and of a material and a score of from 0-50 indicates the darkness of a material. A higher L value indicates the more whiteness of a composition. In the case of a composition containing titanium dioxide, such as a control colorant composition, the color of the composition is white in color and can have an L value of greater than or equal to about 75. In blank compositions herein, that contain no titanium dioxide or no calcium carbonate, the L value is lower than compositions containing titanium dioxide or no calcium carbonate, and the color of such compositions is less opaque and more translucent.

In various aspects, the food colorant replacer compositions or food products herein can have an L value that is equal to or within a predetermined range of a L values. In various aspects, the predetermined range of L values indicative of a whitening effect can include those L values similar to L values recorded for a control colorant composition containing titanium dioxide. In various aspects, the food colorant replacer compositions or food products described herein have an L value or impart an L value in a food product that is from 75 to 90, or an L value of from 75, 76, 77, 78, 79, 80, 81, 82, 83, 84, 85, 86, 87, 88, 89, or 90, or any L value falling within a range of the forgoing. The food colorant replacer compositions or food products herein further can be assayed for a b value to score the measure the yellowness of the composition. In various aspects, the food products containing the food colorant replacer compositions herein, such as egg substitute products, further can contain beta-carotene, a compound having a yellow color, and thus the b values for these compositions are on the positive side of the b scale. The intensity of the b value indicating a yellow color can be directly correlated to the amount of beta-carotene added to the composition. In this way, in various aspects herein, the food products containing food colorant replacer compositions can have a b value that is equal to or within a given range of b values similar to a control colorant composition. In various aspects, the food colorant replacer compositions herein further can be assayed for an a value, however, because the compositions herein are generally white or yellow in color, the green/red score reported by the a value is generally low and not utilized in comparison to the control colorant compositions.

### Methods for Producing Food Colorant Replacer Compositions

The present disclosure also provides a method for producing a food colorant replacer composition for use in food-grade products. The methods herein can include providing a modified food starch, where the modified food starch is obtained by n-octenyl succinic anhydride esterification of starch isolated from waxy maize. The methods further can include providing a soluble rice flour, where the soluble rice flour is obtained by enzymatic treatment of rice flour that is not subjected to any filtering or purification processes. The methods further can include providing calcium carbonate. The methods further can include mixing the modified food starch, the soluble rice flour, and the calcium carbonate to form the food colorant replacer composition. The food colorant replacer composition, including modified food starch, soluble rice flour, and calcium carbonate is suitable for use in various food-grade product compositions to produce a whitening effect. It will be appreciated that the whitening effect can include imparting a whitening effect to a food product.

It will be appreciated that each of the modified food starch, the soluble rice flour, and the calcium carbonate alone do not provide a sufficient whitening effect to a food product. However, it has been surprisingly discovered that the combination of each of these ingredients in a food product synergistically provide a reproducible whitening effect to a food product. Notably, the small portion of insoluble components in the soluble rice flour sediments out of solution in a food product unless the modified food starch is present in the solution at the concentrations described herein. In addition, the low concentrations of calcium carbonate as described herein are generally not sufficient alone to provide whitening effects to a food product unless combined with the modified food starch and soluble rice flour.

The concentrations of each of the modified food starch, the soluble rice flour and calcium carbonate are selected such that individual ingredients act collectively to produce the whitening effect in the food products. The concentration of modified food starch suitable for adding to the food colorant replacer compositions using the methods herein includes from 0.50 wt. % to 2.5 wt. % of the modified food starch in the food product. In some aspects, the concentration of modified food starch suitable for adding to the food colorant replacer compositions using the methods herein includes from 1.0 wt. % to 2.5 wt. %. In various aspects, the concentration of modified food starch suitable for adding to in the food colorant replacer compositions using the methods herein includes from 0.50 wt. %, 0.60 wt. %, 0.70 wt. %, 0.80 wt. %, 0.90 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2.0 wt. %, 2.1 wt. %, 2.2 wt. %, 2.3 wt. %, 2.4 wt. %, or 2.5 wt. %, or a range within any of the forgoing.

The concentration of soluble rice flour suitable for adding to the food colorant replacer compositions using the methods herein includes from 0.10 wt. % to 2.0 wt. % of the soluble rice flour in the food product. In some aspects, the concentration of soluble rice flour suitable for adding to the food colorant replacer compositions using the methods herein includes from 0.10 wt. % to 0.50 wt. %. In various aspects, the concentration of soluble rice flour for adding to the food colorant replacer compositions using the methods herein includes from 0.10 wt. %, 0.20 wt. %, 0.30 wt. %, 0.40 wt. %, 0.5 wt. %, 0.6 wt. %, 0.7 wt. %, 0.80 wt. %, 0.90 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, or 2.0 wt. %, or a range within any of the forgoing.

The concentration of calcium carbonate suitable for adding to the food colorant replacer compositions using the methods herein includes from 0.10 wt. % to 0.76 wt. % of the calcium carbonate in the food product. In some aspects, the concentration of calcium carbonate suitable for adding to the food colorant replacer compositions using the methods herein includes from 0.10 wt. % to 0.15 wt. %. In various aspects, the concentration of calcium carbonate for adding to the food colorant replacer compositions using the methods herein includes from 0.10 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.20 wt. %, 0.25 wt. %, 0.30 wt. %, 0.35 wt. %, 0.40 wt. %, 0.45 wt. %, 0.50 wt. %, 0.55 wt. %, 0.60 wt. %, 0.65 wt. %, 0.70 wt. %, 0.75 wt. %, or 0.76 wt. %, or a range within any of the forgoing.

The methods herein further can include analyzing the L, a, and b color values of the food colorant replacer composition or the food products herein. In various aspects, the method further can include increasing or decreasing one or more concentrations of the modified food starch, the soluble rice flour, or the calcium carbonate to adjust one or more of the L, a, or b color values to within predetermined values, where the predetermined values for L fall within a range of from 75 to 90. In other aspects, the predetermined values for L can be greater than 90.

### Food Products Containing Food Colorant Replacer Compositions

The food colorant replacer compositions herein can be incorporated into a food product composition to impart a whitening effect to the food products. An exemplary food product herein can include an egg substitute product. By way of example, various the egg substitute product suitable for use herein can include pasteurized egg whites. In various aspects, the egg substitute product suitable for use herein does not include egg yolks. The food products herein do not include titanium dioxide, such that the food products are free of titanium dioxide.

It will be appreciated that the food products herein can include any suitable food product that requires whitening properties, such as cream sauces, plant-based meat products, confections, cream substitutes, and the like. In particular aspects, the food products herein can include egg substitute products. In various aspects, the egg substitute products can include egg white substitutes. The egg white substitutes further can include any number of additional ingredients such as beta-carotene, vitamins (e.g., vitamin A palmitate, vitamin B1 (thiamine), vitamin B2 (riboflavin), vitamin B6 (pyridoxine), vitamin B7 (biotin), vitamin B9 (folic acid), vitamin B12 (cobalamin), vitamin D3 (cholecalciferol), vitamin E (tocopherol)), minerals (e.g., calcium sulfate, iron (ferric orthophosphate), zinc sulfate, calcium pantothenate, xanthan gum, guar gum, vegetable oil such as corn oil, canola oil, sunflower oil, soy oil, and the like.

By way of example, an exemplary egg white substitute food product that includes the food colorant replacer composition herein is outlined in Table 1.

TABLE 1
Exemplary Food Product Formulation

| | Exemplary Egg White |
|---|---|
| | Substitute Formulation |
| Ingredient | (w/w %) |
| pasteurized egg whites | 98.130 |
| EmTex ™ 06379 starch | 1.500 |
| SimPure ™ 92260 soluble rice flour | 0.250 |
| calcium carbonate (Omya AG) | 0.120 |
| beta-carotene | 0.025 |

### EXAMPLES

Various aspects of the present disclosure can be better understood by reference to the following Examples, which are offered by way of illustration. The present disclosure is not limited to the Examples given herein.

### Example 1: Materials

Pasteurized egg whites were sourced from Cargill, Inc. (Wayzata, MN, USA).

Various modified food starches were sourced from Cargill Inc. (Wayzata, MN, USA). The modified food starches assayed herein include EmCap™ 06376, EmCap™ 12633, and EmTex™ 06379.

Soluble rice flour (e.g., SimPure™ RF 92260) was sourced from Cargill Inc. (Wayzata, MN, USA).

Avalanche™ M and Avalanche™ M Ultra are proprietary opacifying blends containing calcium carbonate and were sourced from Sensient Technologies Corporation (St. Louis, MO, USA). Calcium carbonate was sourced from Omya AG (Ofringen, Switzerland).

### Example 2: Color Analysis of Food Colorant Replacer Compositions

The experimental formulations containing various food colorant replacer compositions assayed herein were subject to colorimetric analysis using a Minolta CR-410 colorimeter (Minolta, Osaka, Japan). For each experiment, the colorimeter was calibrated against a white tile background. Values for L, a, and b were obtained for each formula to be assayed by placing the colorimeter into the surface of the formulation and recording the results. Control samples including titanium dioxide were similarly assayed for color by recording values for L, a, and b. Results for the colorimetric analysis are reported in the Examples below.

For each formulation, the visual appearance of the composition was observed and a detailed description of each formulation was recorded. The visual description includes, in some cases, a description of the composition and/or a description of the composition relative to the control formulation.

### Example 3: Viscosity Measurements of Experimental Formulations Containing Various Food Colorant Replacer Compositions

The experimental formulations containing various food colorant replacer compositions assayed herein were subject to viscosity measurements using a Minolta CR-410 colorimeter (Minolta, Osaka, Japan). In experiments where viscosity was recorded, viscosity was measured using a Brookfield LVDV-II+ viscometer (Brookfield Ametek, Middleboro, Massachusetts, USA).

### Example 4: Effects of Avalanche™ Calcium Carbonate Blend Concentration on Food Product Color

The assay described in this example includes a comparison of three formulations of a food-grade egg product and the effects of various concentrations of Avalanche™ M or Avalanche™ M Ultra on the color and taste properties of the food product as compared to a titanium dioxide control.

The formulations were created by mixing the ingredients as listed in Table 2. (Values shown are in w/w % unless otherwise indicated). Dry ingredients were weighed and wet ingredients were measured by weight and all were placed into a mixer and combined thoroughly. Each formulation was assayed for pH, visual appearance using colorimetry analysis and visual inspection of the food product appearance, and further assayed for taste by one or more professional sensory evaluators. The blank formula had no titanium dioxide or calcium carbonate. The control included 0.152% w/w titanium dioxide. The experimental formulations included Avalanche™ M orAvalanche™ M Ultra at varying concentrations as follows: Avalanche™ M at 0.456% w/w (Formula 1), Avalanche™ M at 0.608% w/w (Formula 2), and Avalanche™ M Ultra at 0.456% w/w (Formula 3). The composition of each formulation, as well as color and taste data are reported in Table 3. It will be appreciated that the terms “formula” and “formulation” can be used interchangeably throughout the examples herein unless otherwise noted.

TABLE 2
Experimental Formulations 1-3

| | Blank | Control | Formula 1 | Formula 2 | Formula 3 |
|---|---|---|---|---|---|
| Ingredient | (w/w %) | (w/w %) | (w/w %) | (w/w %) | (w/w %) |
| pasteurized egg | 99.170 | 99.170 | 99.170 | 99.170 | 99.170 |
| whites | | | | | |
| titanium dioxide | — | 0.152 | — | — | — |
| Avalanche ™ M | — | — | 0.456 | 0.608 | — |
| Avalanche ™ M | — | — | — | — | 0.456 |
| Ultra | | | | | |
| beta-carotene 2% | 0.025 | 0.025 | 0.025 | 0.025 | 0.025 |
| w/v solution | | | | | |

TABLE 3
Color Data and Taste Results for Formulations 1-3

| | | | | | Visual | Visual | |
|---|---|---|---|---|---|---|---|
| | | Colorimetry Data | | | Appearance | Appearance | Taste |
| Formula | pH | L | a | b | (uncooked) | (cooked) | (cooked) |
| Blank | 8.63 | 53.57 | 0.56 | 35.40 | translucent | opaque bright | — |
| | | | | | | yellow | |
| Control | 8.48 | 80.32 | 2.22 | 32.83 | target opacity, | target opacity, | egg white like |
| | | | | | opaque pale | opaque paler | |
| | | | | | yellow | yellow | |
| Formula 1 | 8.38 | 71.14 | 0.13 | 50.94 | opaque green | off yellow | cereal like |
| Formula 2 | 8.39 | 73.26 | −0.41 | 50.35 | opaque green | opaque dark | cereal like |
| | | | | | | off yellow | |
| Formula 3 | 8.54 | 67.20 | 3.16 | 46.23 | translucent to | opaque | cereal like |
| | | | | | opaque dark | pale yellow | |
| | | | | | yellow | | |

Formula 1 provided an opaque green composition when uncooked and an off yellow composition when cooked, where the cooked taste was described as tasking like cereal. Similarly, Formulas 2 and 3 provided opaque green and opaque yellow compositions, respectively, when uncooked and dark-yellow and pale-yellow color, respectively, when cooked, that when cooked were described as having a cereal like taste. None of the formulations 1-3 were suitable to provide a colorant composition to the food-grade egg product due to undesired color and taste.

### Example 5: Effects of Omya Calcium Carbonate Concentration on Food Product Color

The assay described in this example includes a comparison of three formulations of a food-grade egg product and the effects of various concentrations of calcium carbonate (Omya AG, Oftringen, Switzerland) on the color properties of the food product as compared to a titanium dioxide control.

The formulations were created by mixing the ingredients as listed in Table 4. (Values shown are in % in w/w unless otherwise indicated). Dry ingredients were weighed and wet ingredients were measured volumetrically and all were placed into a mixer and combined thoroughly. Each formulation was assayed for visual appearance using colorimetry analysis and visual inspection of the food product appearance. The control included 0.152% w/w titanium dioxide. The experimental formulations included calcium carbonate at varying concentrations as follows: 0.456% w/w (Formula 4) and 0.760% w/w (Formula 5). Color data for each formulation are reported in Table 5.

TABLE 4
Experimental Formulations 4-5

| | Control | Formula 4 | Formula 5 |
|---|---|---|---|
| Ingredient | (w/w %) | (w/w %) | (w/w %) |
| pasteurized egg whites | 99.170 | 99.170 | 99.170 |
| titanium dioxide | 0.152 | — | — |
| calcium carbonate (Omya AG) | — | 0.456 | 0.760 |
| beta-carotene 2% w/v solution | 0.025 | 0.025 | 0.025 |

TABLE 5
Color Data for Formulations 4-5

| | Colorimetry Data | | | Visual |
|---|---|---|---|---|
| Formula | L | a | b | Appearance |
| Control | 83.06 | −2.10 | 50.44 | target opacity, |
| (uncooked) | | | | opaque |
| | | | | pale yellow |
| Formula 4 | 78.85 | −1.47 | 56.81 | opaque |
| (uncooked) | | | | bright yellow |
| Formula 5 | 81.06 | −1.90 | 58.90 | opaque |
| (uncooked) | | | | pale yellow |
| Control | 88.87 | −7.64 | 61.73 | |
| (cooked) | | | | |
| Formula 4 | 89.31 | −7.52 | 57.56 | |
| (cooked) | | | | |
| Formula 5 | 89.44 | −8.24 | 57.5 | — |
| (cooked) | | | | |

Formulas 4 and 5 provided opaque bright-yellow and pale-yellow compositions, respectively, when uncooked. Formula 5 had a visual appearance similar to the control as supported by the visual appearance and the colorimetry data, where the color values (L, a, and b) for the control include (83.06, −2.10, 50.44) and the colorimetry data for formulation 5 include (81.06, −1.90, 58.90).

### Example 6: Effects of Varying Concentrations of Modified Food Starches and Calcium Carbonate on Food Product Color

The assay described in this example includes a comparison of various formulations of a food-grade egg product and the effects of various concentrations of modified food starches alone or in combination with calcium carbonate on the visual properties of the food product as compared to a titanium dioxide control.

The formulations were created by mixing the ingredients as listed in Table 6. (Values shown are in % in w/w unless otherwise indicated). Dry ingredients were weighed and wet ingredients were measured volumetrically and all were placed into a mixer and combined thoroughly. Each formulation was assayed for visual appearance using colorimetry analysis and visual inspection of the food product appearance. The blank formula had no titanium dioxide or calcium carbonate. The control included 0.152% w/w titanium dioxide. The experimental formulations included various concentrations of modified food starch, alone or in combination with calcium carbonate, as follows: 1.00% w/w EmCap™ 06376 (Formula 6); 2.00% w/w EmCap™ 06376 (Formula 7); 1.00% w/w EmCap™ 06376 and 0.150% w/w CaCO₃ (Formula 8); and 1.00% w/w EmCap™ 12633 and 0.150% w/w CaCO₃ (Formula 9). Color data for each formulation are reported in Table 7.

TABLE 6
Experimental Formulations 6-9

| | | | Formula | Formula | Formula | Formula |
|---|---|---|---|---|---|---|
| | Blank | Control | 6 | 7 | 8 | 9 |
| Ingredient | (w/w %) | (w/w %) | (w/w %) | (w/w %) | (w/w %) | (w/w %) |
| pasteurized egg | 99.170 | 99.170 | 99.170 | 99.170 | 99.170 | 99.170 |
| whites | | | | | | |
| titanium dioxide | — | 0.152 | — | — | — | — |
| EmCap ™ | — | — | 1.00 | 2.00 | 1.00 | — |
| 06376 starch | | | | | | |
| EmCap ™ | — | — | — | — | — | 1.00 |
| 12633 starch | | | | | | |
| calcium | — | — | 0 | 0 | 0.150 | 0.150 |
| carbonate | | | | | | |
| (Omya AG) | | | | | | |
| beta-carotene | 0.025 | 0.025 | 0.025 | 0.025 | 0.025 | 0.025 |
| 2% w/v solution | | | | | | |

TABLE 7
Color Data for Formulations 6-9

| | Colorimetry Data | | | Visual |
|---|---|---|---|---|
| Formula | L | a | b | Appearance |
| Blank | 65.18 | −0.48 | 42.59 | translucent |
| (uncooked) | | | | yellow |
| Control | 79.36 | −0.93 | 56.09 | target opacity, |
| (uncooked) | | | | opaque pale yellow |
| Formula 6 | 69.45 | −0.59 | 57.91 | translucent |
| (uncooked) | | | | |
| Formula 7 | 73.23 | −0.53 | 59.57 | opaque |
| (uncooked) | | | | pale yellow |
| Formula 8 | 76.68 | −0.37 | 59.05 | opaque |
| (uncooked) | | | | pale yellow |
| Formula 9 | 79.03 | −1.93 | 56.91 | opaque |
| (uncooked) | | | | pale yellow |
| Control | 87.69 | −7.22 | 61.12 | yellow cooked |
| (cooked) | | | | egg color |
| Formula 8 | 87.11 | −7.01 | 57.21 | yellow cooked |
| (cooked) | | | | egg color |
| Formula 9 | 88.85 | −8.06 | 57.99 | yellow cooked |
| (cooked) | | | | egg color |

Formulations 7, 8, and 9 provided opaque pale-yellow compositions when uncooked. Formulation 6 was translucent as compared to the control formulation. Formulations 8 and 9 had a visual appearance of a conventional cooked yellow egg color, and this was also observed in the control and as supported by similar colorimetric data values. Color values (L, a, and b) for the control include (79.36, −0.93, 56.09) and the colorimetry data for formulation 8 include (76.68, −0.37, 59.05) and for formulation 9 include (79.03, −1.93, 56.91).

### Example 7: Effects of EmCap™ 12633 Starch and Varying Concentrations of Calcium Carbonate on Food Product Color

The assay described in this example includes a comparison of various formulations of a food-grade egg product and the effects of various concentrations of calcium carbonate combined with the modified food starch EmCap12633 on the visual properties of the food product as compared to a titanium dioxide control.

The formulations were created by mixing the ingredients as listed in Table 8. (Values shown are in % in w/w unless otherwise indicated). Dry ingredients were weighed and wet ingredients were measured volumetrically and all were placed into a mixer and combined thoroughly. Each formulation was assayed for visual appearance using colorimetry analysis and visual inspection of the food product appearance. The control included 0.152% w/w titanium dioxide. The experimental formulations included EmCap™ 12633 modified food starch and various concentrations of calcium carbonate, as follows: 1.00% w/w EmCap™ 12633 and 0.100% w/w CaCO₃ (Formula 10); 1.00% w/w EmCap™ 12633 and 0.120% w/w CaCO₃ (Formula 11); and 1.00% w/w EmCap™ 12633 and 0.140% w/w CaCO₃ (Formula 12). Color data for each formulation (uncooked) are reported in Table 9.

TABLE 8
Experimental Formulations 10-12

| | | Formula | Formula | Formula |
|---|---|---|---|---|
| | Control | 10 | 11 | 12 |
| Ingredient | (w/w %) | (w/w %) | (w/w %) | (w/w %) |
| pasteurized egg | 98.372 | 98.372 | 98.372 | 98.372 |
| whites | | | | |
| titanium dioxide | 0.152 | — | — | — |
| EmCap™ 12633 | — | 1.00 | 1.00 | 1.00 |
| Starch | | | | |
| calcium carbonate | — | 0.100 | 0.120 | 0.140 |
| (Omya AG) | | | | |
| beta-carotene 2% | 0.025 | 0.025 | 0.025 | 0.025 |
| w/v solution | | | | |

TABLE 9
Color Data for Formulations 10-12

| | Colorimetry Data | | | |
|---|---|---|---|---|
| Formula | L | a | b | Visual Appearance |
| Control | 77.68 | −0.43 | 47.54 | target opacity, |
| | | | | opaque pale yellow |
| Formula 10 | 75.37 | 1.71 | 51.05 | opaque bright yellow |
| Formula 11 | 75.9 | 0.23 | 43.84 | opaque light yellow |
| Formula 12 | 76.45 | −0.43 | 56.89 | opaque light yellow |

Formulations 11 and 12 provided opaque light-yellow compositions similar to the control in the uncooked state but too light to be considered a formulation suitable as a colorant composition for the food-grade egg product. Formulation 10 produced a bright opaque yellow color as observed relative to the control, also considered too divergent from the control to be a formulation suitable as a colorant composition for the food-grade egg product.

### Example 8: Effects of Varying Concentrations of Modified Food Starch and Calcium Carbonate on Food Product Color

The assay described in this example includes a comparison of various formulations of a food-grade egg product and the effects of various concentrations of the modified food starch EmCap12633 and calcium carbonate on the visual properties of the food product as compared to a titanium dioxide control.

The formulations were created by mixing the ingredients as listed in Table 10. (Values shown are in % in w/w unless otherwise indicated). Dry ingredients were weighed and wet ingredients were measured volumetrically and all were placed into a mixer and combined thoroughly. Each formulation was assayed for visual appearance using colorimetry analysis and visual inspection of the food product appearance. The control included 0.152% w/w titanium dioxide. The experimental formulations included EmCap™ 12633 modified food starch and calcium carbonate, as follows: 1.00% w/w EmCap™ 12633 and 0.100% w/w CaCO₃ (Formula 13); 1.50% w/w EmCap™ 12633 and 0.100% w/w CaCO₃ (Formula 14); and 2.00% w/w EmCap™ 12633 and 0.100% w/w CaCO₃ (Formula 15). Color data for each formulation (uncooked) are reported in Table 11.

TABLE 10
Experimental Formulations 13-15

| | | Formula | Formula | Formula |
|---|---|---|---|---|
| | Control | 13 | 14 | 15 |
| Ingredient | (w/w %) | (w/w %) | (w/w %) | (w/w %) |
| pasteurized egg | 98.372 | 98.372 | 98.372 | 98.372 |
| whites | | | | |
| titanium dioxide | 0.152 | — | — | — |
| EmCap™ 12633 | — | 1.000 | 1.500 | 2.000 |
| Starch | | | | |
| calcium carbonate | — | 0.100 | 0.100 | 0.100 |
| (Omya AG) | | | | |
| beta-carotene 2% | 0.025 | 0.025 | 0.025 | 0.025 |
| w/v solution | | | | |

TABLE 11
Color Data for Formulations 13-15

| | Colorimetry Data | | | |
|---|---|---|---|---|
| Formula | L | a | b | Visual Appearance |
| Control | 78.7 | 1.92 | 50.54 | target opacity, |
| | | | | opaque pale yellow |
| Formula 13 | 76.13 | 2.18 | 53.42 | opaque bright yellow |
| Formula 14 | 76.8 | 1.15 | 48.69 | opaque pale yellow |
| Formula 15 | 74.53 | 1.29 | 44.43 | translucent pale yellow |

Formulation 14 provided an opaque pale-yellow composition similar in visual appearance to the control in the uncooked state and as supported by similar colorimetric values. Color values (L, a, and b) for the control include (78.7, 1.92, 50.54) and the colorimetry data for formulation N include (76.8, 1.15, 48.69). Formulation 13 produced a bright opaque yellow color as observed relative to the control and formulation 15 produced a translucent pale-yellow composition, both of which were considered to be too divergent from the control to be a formulation suitable as a colorant composition for the food-grade egg product.

### Example 9: Effects of Various Concentrations of Modified Food Starches and of Calcium Carbonate on Food Product Color

The assay described in this example includes a comparison of various formulations of a food-grade egg product and the effects of various concentrations of the modified food starch EmCap™ 12633, EmCap™ 06376, or EmTex™ 06379 and varying calcium carbonate concentrations on the visual properties of the food product as compared to a titanium dioxide control.

The formulations were created by mixing the ingredients as listed in Table 12. (Values shown are in % in w/w unless otherwise indicated). Dry ingredients were weighed and wet ingredients were measured volumetrically and all were placed into a mixer and combined thoroughly. Each formulation was assayed for visual appearance using colorimetry analysis and visual inspection of the food product appearance. The viscosity in centipoise (cP) was measured as described in Example 3 and recorded. The control included 0.152% w/w titanium dioxide. The experimental formulations included EmTex™ 06379, EmCap™ 06376, or EmCap™ 12633 modified food starches and calcium carbonate, as follows: 1.50% w/w EmTex™ 06379 and 0.150% w/w CaCO₃ (Formula 16); 1.50% w/w EmCap™ 06376 and 0.150% w/w CaCO₃ (Formula 17); 1.50% w/w EmCap™ 12633 and 0.150% w/w CaCO₃ (Formula 18); 1.50% w/w EmTex™ 06379 and 0.120% w/w CaCO₃ (Formula 19), 1.50% w/w EmCap™ 06376 and 0.120% w/w CaCO₃ (Formula 20), 1.50% w/w EmCap™ 12633 and 0.120% w/w CaCO₃ (Formula 21). Color and viscosity data for each formulation (uncooked) are reported in Table 13.

TABLE 12
Experimental Formulations 16-21

| | | Formula | Formula | Formula | Formula | Formula | Formula |
|---|---|---|---|---|---|---|---|
| Ingredient | Control | 16 | 17 | 18 | 19 | 20 | 21 |
| pasteurized | 98.372 | 98.372 | 98.372 | 98.372 | 98.372 | 98.372 | 98.372 |
| egg whites | | | | | | | |
| titanium | 0.152 | — | — | — | — | — | — |
| dioxide | | | | | | | |
| EmTex ™ | — | 1.50 | — | — | 1.50 | — | — |
| 06379 | | | | | | | |
| starch | | | | | | | |
| EmCap ™ | — | — | 1.50 | — | — | 1.50 | — |
| 06376 | | | | | | | |
| starch | | | | | | | |
| EmCap ™ | — | — | — | 1.50 | — | — | 1.50 |
| 12633 | | | | | | | |
| starch | | | | | | | |
| calcium | — | 0.150 | 0.150 | 0.150 | 0.120 | 0.120 | 0.120 |
| carbonate | | | | | | | |
| (Omya AG) | | | | | | | |
| beta-carotene | 0.025 | 0.025 | 0.025 | 0.025 | 0.025 | 0.025 | 0.025 |
| 2% w/v | | | | | | | |
| solution | | | | | | | |

TABLE 13
Color and Viscosity Data for Formulations 16-21

| | Colorimetry Data | | | Viscosity | |
|---|---|---|---|---|---|
| Formula | L | a | b | (cP) | Visual Appearance |
| Control | 80.12 | 0.88 | 51.93 | 285 | target opacity, |
| | | | | | opaque pale yellow |
| Formula 16 | 76.2 | 1.63 | 55.4 | 346 | opaque pale yellow, |
| | | | | | no separation |
| Formula 17 | 72.44 | 2.88 | 53.29 | 334 | opaque light yellow, |
| | | | | | no separation |
| Formula 18 | 73.82 | 1.44 | 55.01 | 250 | translucent, |
| | | | | | solution separated |
| Formula 19 | 76.03 | 1.25 | 55.88 | 338 | opaque pale yellow, |
| | | | | | no separation |
| Formula 20 | 72.38 | 2.66 | 53.33 | 334 | opaque light yellow, |
| | | | | | no separation |
| Formula 21 | 73.9 | 1.09 | 53.8 | 242 | translucent, |
| | | | | | solution separated |

Formulation 16 produced an opaque pale-yellow composition similar to the control in the uncooked state and supported by the colorimetric data. Color values (L, a, and b) for the control include (80.12, 0.88, 51.93) and the colorimetry data for formulation 16 include (76.2, 1.63, 55.4). Formulations 17, 18, and 20 produced an opaque light-yellow color that was close to the control color, both upon visual inspection and by colorimetry, however they were considered too light for formulation as a color composition in the food-grade egg product. Notably formulations 16, 17, 19, and 20 did not separate following the mixing process, but formulations 18 and 21 produced mixture that separated out of solution and became translucent after sitting for a period of time. Formulations 18 and 21 resulted in translucent compositions with undesirable color properties for use as a color composition in the food-grade egg product.

### Example 10: Effects of EmTex06379, Soluble Rice Flour, and Calcium Carbonate on Food Product Color

The assays described in this example includes a comparison of various formulations of a food-grade egg product and the effects of the modified food starch EmTex™ 06379, calcium carbonate, and various concentrations of the soluble rice flour SimPure™ 92260 on the visual properties of the food product as compared to a titanium dioxide control.

Various formulations were created by mixing the ingredients as listed in Table 14. (Values shown are in % in w/w unless otherwise indicated). Dry ingredients were weighed and wet ingredients were measured volumetrically and all were placed into a mixer and combined thoroughly. Each formulation was assayed for visual appearance using colorimetry analysis and visual inspection of the food product appearance. The viscosity in centipoise (cP) was measured as described in Example 3 and recorded. The control included 0.152% w/w titanium dioxide. The experimental formulations included EmTex™ 06379 modified food starch, calcium carbonate, and SimPure™ 92260 soluble rice flour, as follows: 1.50% w/w EmTex™ 06379 and 0.120% w/w CaCO₃ (Formula 20 from Example 9); 1.50% w/w EmTex™ 06379, 0.120% w/w CaCO₃, and 0.250% w/w SimPure™ 92260 (Formula 22); 1.50% w/w EmTexu 06379, 0.120% w/w CaCO₃, and 0.500% w/w SimPure™ 92260 (Formula 23); 1.50% w/w EmTex™ 06379, 0.120% w/w CaCO₃, and 1.00% w/w SimPure™ 92260 (Formula 24); and 1.50% w/w EmTex™ 06379, 0.120% w/w CaCO₃, and 2.00% w/w SimPure™ 92260 (Formula 25). Formula 20, from Example 9, containing no SimPure™ 92260 soluble rice flour, was used for comparative purposes. Color and viscosity data for each formulation (uncooked) are reported in Table 15.

TABLE 14
Experimental Formulations 22-25

| | | Formula | Formula | Formula | Formula | Formula |
|---|---|---|---|---|---|---|
| | Control | 20 | 22 | 23 | 24 | 25 |
| Ingredient | (w/w %) | (w/w %) | (w/w %) | (w/w %) | (w/w %) | (w/w %) |
| pasteurized | 99.250 | 99.250 | 99.250 | 99.250 | 99.250 | 99.250 |
| egg whites | | | | | | |
| titanium | 0.152 | — | — | — | — | — |
| dioxide | | | | | | |
| EmTex ™ | — | 1.50 | 1.50 | 1.50 | 1.50 | 1.50 |
| 06379 | | | | | | |
| starch | | | | | | |
| calcium | — | 0.120 | 0.120 | 0.120 | 0.120 | 0.120 |
| carbonate | | | | | | |
| (Omya AG) | | | | | | |
| SimPure ™ | — | — | 0.250 | 0.500 | 1.00 | 2.00 |
| 92260 soluble | | | | | | |
| rice flour | | | | | | |
| beta-carotene | 0.025 | 0.025 | 0.025 | 0.025 | 0.025 | 0.025 |
| 2% w/v | | | | | | |
| solution | | | | | | |

TABLE 15
Color and Viscosity Data for Formulations 22-25

| | Colorimetry Data | | | Viscosity | |
|---|---|---|---|---|---|
| Formula | L | a | b | (cP) | Visual Appearance |
| Control | — | — | — | — | target opacity, |
| | | | | | opaque pale yellow |
| Formula 20 | 71.26 | 3.88 | 54.02 | 122 | opaque pale yellow, |
| | | | | | similar to control |
| Formula 22 | 75.44 | 2.81 | 53.86 | 263 | no increase in opacity |
| | | | | | relative to formula 20 |
| Formula 23 | 75.57 | 2.66 | 53.49 | 267 | no increase in opacity |
| | | | | | relative to formula 20 |
| Formula 24 | 75.72 | 2.43 | 53.25 | 290 | no increase in opacity |
| | | | | | relative to formula 20 |
| Formula 25 | 76.45 | 1.38 | 49.62 | 290 | no increase in opacity |
| | | | | | relative to formula 20 |

Formulations 22, 23, 24, and 25 provided opaque pale-yellow compositions with no increased opacity relative to the control.

Surprisingly, it was found that the insoluble portion of the soluble rice flour did not stay in solution unless present in the mixture with a modified food starch.

### Example 11: Effects of Various Concentrations Modified Food Starch and Various Concentrations of Soluble Rice Flour and Calcium Carbonate on Food Product Color

The assay described in this example includes a comparison of various formulations of a food-grade egg product and the effects of various concentrations of the modified food starch EmTex™ 06379, various concentrations of calcium carbonate, and various concentrations of the soluble rice flour SimPure™ 92260 on the visual properties of the food product as compared to a titanium dioxide control.

Various formulations were created by mixing the ingredients as listed in Table 16. (Values shown are in % in w/w unless otherwise indicated). Dry ingredients were weighed and wet ingredients were measured volumetrically and all were placed into a mixer and combined thoroughly. Each formulation was assayed for visual appearance using colorimetry analysis and visual inspection of the food product appearance. The viscosity in centipoise (cP) was measured as described in Example 3 and recorded. The control included 0.152% w/w titanium dioxide. The experimental formulations included EmTex™ 06379 modified food starch, calcium carbonate, and SimPure™ 92260 soluble rice flour, as follows: 0.500% w/w EmTex™ 06379, 0.120% w/w CaCO₃, and 0.500% SimPure™ 92260 (Formula 26); 1.00% w/w EmTex™ 06379, 0.120% w/w CaCO₃, and 0.500% w/w SimPure™ 92260 (Formula 27); 1.50% w/w EmTex™ 06379, 0.120% w/w CaCO₃, and 0.500% w/w SimPure™ 92260 (Formula 28); 0.500% w/w EmTex™ 06379, 0.120% w/w CaCO₃, and 0.250% w/w SimPure™ 92260 (Formula 29); 1.00% w/w EmTex™ 06379, 0.120% w/w CaCO₃, and 0.250% w/w SimPure™ 92260 (Formula 30); and 1.50% w/w EmTex™ 06379, 0.120% w/w CaCO₃, and 0.250% w/w SimPure™ 92260 (Formula 31). Color and viscosity data for each formulation (uncooked) are reported in Table 17.

TABLE 16
Experimental Formulations 26-31

| | | Formula | Formula | Formula | Formula | Formula | Formula |
|---|---|---|---|---|---|---|---|
| | Control | 26 | 27 | 28 | 29 | 30 | 31 |
| Ingredient | (w/w %) | (w/w %) | (w/w %) | (w/w %) | (w/w %) | (w/w %) | (w/w %) |
| pasteurized | 99.250 | 98.602 | 98.602 | 98.602 | 98.602 | 98.602 | 98.602 |
| egg whites | | | | | | | |
| titanium | 0.152 | — | — | — | — | — | — |
| dioxide | | | | | | | |
| EmTex ™ | — | 0.500 | 1.00 | 1.50 | 0.500 | 1.00 | 1.50 |
| 06379 starch | | | | | | | |
| SimPure ™ | — | 0.500 | 0.500 | 0.500 | 0.250 | 0.250 | 0.250 |
| 92260 soluble | | | | | | | |
| rice flour | | | | | | | |
| calcium | — | 0.120 | 0.120 | 0.120 | 0.120 | 0.120 | 0.120 |
| carbonate | | | | | | | |
| (Omya AG) | | | | | | | |
| beta-carotene | 0.025 | 0.025 | 0.025 | 0.025 | 0.025 | 0.025 | 0.025 |
| 2% w/v | | | | | | | |
| solution | | | | | | | |

TABLE 17
Color and Viscosity Data for Formulations 26-31

| | Colorimetry Data | | | Viscosity | |
|---|---|---|---|---|---|
| Formula | L | a | b | (cP) | Visual Appearance |
| Control | 78.89 | 1.87 | 43.84 | 47 | target opacity, |
| | | | | | opaque pale yellow |
| Formula 26 | 69.73 | 4.26 | 41.62 | 87 | opaque pale yellow, |
| | | | | | similar to control |
| Formula 27 | 71.43 | 4.47 | 51.93 | 195 | opaque pale yellow, |
| | | | | | similar to control |
| Formula 28 | 72.72 | 4.14 | 54.8 | 225 | opaque pale yellow, |
| | | | | | most similar to control |
| Formula 29 | 67.07 | 5.38 | 53.18 | 99 | bright yellow, less |
| | | | | | opaque than control |
| Formula 30 | 69.31 | 4.95 | 54.1 | 124 | opaque pale yellow, |
| | | | | | similar to control |
| Formula 31 | 71.73 | 4.55 | 55.83 | 173 | opaque pale yellow, |
| | | | | | similar to control |

Formulation 28 produced an opaque pale-yellow composition closest to the control in the uncooked state and supported by the colorimetric data. Color values (L, a, and b) for the control include (78.89, 1.87, 43.84) and the colorimetry data for formulation 28 include (72.72, 4.14, 54.8). Formulation 27 produced an opaque pale-yellow composition similar to the control in the uncooked state and supported by the colorimetric data. Color values (L, a, and b) for the control include (78.89, 1.87, 43.84) and the colorimetry data for formulation 27 include (71.43, 4.47, 51.93). Formulations 30 and 31 produced an opaque pale-yellow color that was close to the control color, both upon visual inspection and by colorimetry. Formulation 29 produced an opaque bright yellow color considered too bright for formulation as a color composition in the food-grade egg product.

### Example 12: Effects of Modified Food Starches and Various Concentrations of Beta-Carotene on Food Product Color

The assay described in this example includes a comparison of various formulations of a food-grade egg product and the effects of various concentrations of beta-carotene and xanthan gum on formulations containing 1.50% w/w of the modified food starch EmTex™ 06379, 0.120% w/w of calcium carbonate (Omya AG, Oftringen, Switzerland), and 0.250% w/w of the soluble rice flour SimPure™ 92260 on the visual properties of the product as compared to a titanium dioxide control.

The formulations were created by mixing the ingredients as listed in Table 18. (Values shown are in % in w/w unless otherwise indicated). Dry ingredients were weighed and wet ingredients were measured volumetrically and all were placed into a mixer and combined thoroughly. Each formulation was assayed for visual appearance using colorimetry analysis and visual inspection of the food product appearance. The viscosity in centipoise (cP) was measured as described in Example 3 and recorded. The control included 0.152% w/w titanium dioxide. The experimental formulations included EmTex™ 06379 modified food starch or EmCap™ 12633 modified food starch, calcium carbonate, SimPure™ 92260 soluble rice flour, beta-carotene, and xanthan gum, as follows: 1.500% w/w EmCap™ 12633, 0.120% w/w CaCO₃, 0.250% w/w SimPure™ 92260, 0.020% w/w beta-carotene, and 0.100% w/w xanthan gum (Formula 32); 1.50% w/w EmTex™ 06379, 0.120% w/w CaCO₃, 0.250% w/w SimPure™ 92260, 0.020% w/w beta-carotene, and 0.100% w/w xanthan gum (Formula 33); and 1.50% w/w EmTex™ 06379, 0.120% w/w CaCO₃, 0.250% w/w SimPure™ 92260, 0.010% w/w beta-carotene, and 0.100% w/w xanthan gum (Formula 34). Color and viscosity data for each formulation (uncooked) are reported in Table 19.

TABLE 18
Experimental Formulations 32-34

| | | Formula | Formula | Formula |
|---|---|---|---|---|
| | Control | 32 | 33 | 34 |
| Ingredient | (w/w %) | (w/w %) | (w/w %) | (w/w %) |
| pasteurized egg whites | 99.250 | 97.696 | 97.696 | 97.696 |
| titanium dioxide | 0.152 | — | — | — |
| EmCap™ 12633 starch | — | 1.50 | — | |
| EmTex™ 06379 starch | | | 1.50 | 1.50 |
| SimPure™ 92260 soluble rice flour | — | 0.250 | 0.250 | 0.250 |
| calcium carbonate (Omya AG) | — | 0.120 | 0.120 | 0.120 |
| beta-carotene 2% w/v solution | 0.025 | 0.020 | 0.020 | 0.010 |

TABLE 19
Color and Viscosity Data for Formulations 32-34

| | Colorimetry Data | | | Viscosity | |
|---|---|---|---|---|---|
| Formula | L | a | b | (cP) | Visual Appearance |
| Control | 79.97 | 0.66 | 52.58 | 122 | target opacity, |
| | | | | | opaque pale yellow |
| Formula 32 | 69.46 | 2.39 | 52.28 | 53 | bright yellow, |
| | | | | | less opaque |
| | | | | | than control |
| Formula 33 | 74.85 | 1.93 | 54.11 | 140 | opaque pale yellow, |
| | | | | | not close |
| | | | | | enough to control |
| Formula 34 | 76.51 | 0.31 | 49.56 | 154 | close to control |
| | | | | | target opacity of |
| | | | | | opaque pale yellow |

Formulation 34 produced the most optimal color of opaque pale-yellow similar to the control in the uncooked state and supported by the colorimetric data. Color values (L, a, and b) for the control include (79.97, 0.66, 52.58) and the colorimetry data for formulation 34 include (76.51, 0.31, 49.56). Formulations 32 and 33 produced compositions having bright-yellow color or pale-yellow color similar to the control, but not the desired color properties for use as a color composition in the food-grade egg product.

### Example 13: Effects of Individual Ingredients on Food Product Color

The assay described in this example investigates the effects of individual components of the food colorant replacer composition on the final color a food-grade egg product. This example details the contribution of each component the composition to the whitening effect in the food product by looking individually at the contribution of various concentrations of calcium carbonate, EmTex™ 06379 starch, and SimPure™ 92260 soluble rice flour.

In Sample Set 1, the effects of calcium carbonate at concentrations ranging from 0.150% w/w to 1.500% w/w were investigated. In Sample Set 2, the effects of EmTex™ 06379 starch concentrations ranging from 0.500% w/w to 3.000% w/w were investigated. In Sample Set 3, the effects of SimPure™ 92260 soluble rice flour concentrations ranging from 0.250% w/w to 3.000% w/w were investigated. The base food product formulation used in each formulation studied in Sample Sets 1 to 3 is shown in Table 20.

TABLE 20
Base Formulation

| | Exemplary |
|---|---|
| | Egg White |
| | Substitute |
| | Formulation |
| Ingredient | (w/w %) |
| pasteurized egg whites | 96-99.5 |
| soybean oil | 0.500 |
| xanthan gum | 0.150 |
| beta-carotene | 0.250 |

For Sample Set 1, the effects of calcium carbonate at concentrations including 0.0% w/w, 0.150% w/w, 0.450% w/w, 0.750% w/w, and 1.500% w/w were investigated. The formulations used for Sample Set 1 are included in Table 21.

TABLE 21
Sample Set 1: Base Formulation Including Varying Calcium Carbonate

| | | Formula | Formula | Formula | Formula | Formula |
|---|---|---|---|---|---|---|
| | Control | 35 | 36 | 37 | 38 | 39 |
| Ingredient | (w/w %) | (w/w %) | (w/w %) | (w/w %) | (w/w %) | (w/w %) |
| pasteurized egg | 99.325 | 99.175 | 99.175 | 98.875 | 98.575 | 97.825 |
| whites | | | | | | |
| soybean oil | 0.500 | 0.500 | 0.500 | 0.500 | 0.500 | 0.500 |
| xanthan gum | 0.150 | 0.150 | 0.150 | 0.150 | 0.150 | 0.150 |
| beta-carotene | 0.025 | 0.025 | 0.025 | 0.025 | 0.025 | 0.025 |
| titanium dioxide | 0 | 0.150 | 0 | 0 | 0 | 0 |
| calcium carbonate | 0 | 0 | 0.150 | 0.450 | 0.750 | 1.500 |

For Sample Set 2, the effects of EmTex™ 06379 starch concentrations including 0.0% w/w, 0.500% w/w, 1.000% w/w, 1.500% w/w, 2.000% w/w, and 3.000% w/w were investigated. The formulations used for Sample Set 2 are included in Table 22.

TABLE 22
Sample Set 2: Base Formulation Including EmTex ™ 06379 Starch

| | | Formula | Formula | Formula | Formula | Formula | Formula |
|---|---|---|---|---|---|---|---|
| | Control | 40 | 41 | 42 | 43 | 44 | 45 |
| Ingredient | (w/w %) | (w/w %) | (w/w %) | (w/w %) | (w/w %) | (w/w %) | (w/w %) |
| pasteurized | 99.325 | 99.175 | 98.825 | 98.325 | 97.825 | 97.325 | 96.325 |
| egg whites | | | | | | | |
| soybean oil | 0.500 | 0.500 | 0.500 | 0.500 | 0.500 | 0.500 | 0.500 |
| xanthan | 0.150 | 0.150 | 0.150 | 0.150 | 0.150 | 0.150 | 0.150 |
| gum | | | | | | | |
| beta- | 0.025 | 0.025 | 0.025 | 0.025 | 0.025 | 0.025 | 0.025 |
| carotene | | | | | | | |
| titanium | 0 | 0.150 | 0 | 0 | 0 | 0 | 0 |
| dioxide | | | | | | | |
| calcium | 0 | 0 | 0 | 0 | 0 | 0 | 0 |
| carbonate | | | | | | | |
| EmTex ™ | 0 | 0 | 0.500 | 1.000 | 1.500 | 2.000 | 3.000 |
| 06379 | | | | | | | |
| starch | | | | | | | |

For Sample Set 3, the effects of SimPure™ 92260 soluble rice flour concentrations including 0.0% w/w, 0.250% w/w, 0.500% w/w, 1.000% w/w, 2.0000% w/w, and 3.000% w/w were investigated. The formulations used for Sample Set 2 are included in Table 23.

TABLE 23
Sample Set 3: Base Formulation Including Varying SimPure ™ 92260 Soluble Rice Flour

| | | Formula | Formula | Formula | Formula | Formula | Formula |
|---|---|---|---|---|---|---|---|
| | Control | 46 | 47 | 48 | 49 | 50 | 51 |
| Ingredient | (w/w %) | (w/w %) | (w/w %) | (w/w %) | (w/w %) | (w/w %) | (w/w %) |
| pasteurized | 99.325 | 99.175 | 99.075 | 98.825 | 98.325 | 97.325 | 96.325 |
| egg whites | | | | | | | |
| soybean oil | 0.500 | 0.500 | 0.500 | 0.500 | 0.500 | 0.500 | 0.500 |
| xanthan | 0.150 | 0.150 | 0.150 | 0.150 | 0.150 | 0.150 | 0.150 |
| gum | | | | | | | |
| beta- | 0.025 | 0.025 | 0.025 | 0.025 | 0.025 | 0.025 | 0.025 |
| carotene | | | | | | | |
| titanium | 0 | 0.150 | 0 | 0 | 0 | 0 | 0 |
| dioxide | | | | | | | |
| calcium | 0 | 0 | 0 | 0 | 0 | 0 | 0 |
| carbonate | | | | | | | |
| EmTex ™ | 0 | 0 | 0 | 0 | 0 | 0 | 0 |
| 06379 | | | | | | | |
| starch | | | | | | | |
| SimPure ™ | 0 | 0 | 0.250 | 0.500 | 1.000 | 2.000 | 3.000 |
| 92260 | | | | | | | |

Color and viscosity data for each formulation (uncooked) detailed for Sample Sets 1 to 3 are reported in Table 24. Note colorimetry data for formulas 40 and 46 have been omitted from the color and viscosity data, as they are the same composition as formula 35.

TABLE 24
Color and Viscosity Data for Formulations 35-51

| | Colorimetry Data | | | Viscosity | | |
|---|---|---|---|---|---|---|
| Formula | L | a | b | (cP) | pH | Visual Appearance |
| Control | 49.18 | −3.83 | 28.05 | 89.5 | 8.85 | translucent yellow |
| Formula 35 | 81.65 | −1.57 | 49.36 | 144.5 | 8.87 | opaque and paler |
| Formula 36 | 65.46 | −1.83 | 47.65 | 134 | 8.94 | slight change from |
| | | | | | | control |
| Formula 37 | 73.38 | −2.13 | 52.65 | 140 | 8.91 | |
| Formula 38 | 77.65 | −1.94 | 52.68 | 135.5 | 8.94 | similar to TiO₂ |
| | | | | | | control |
| Formula 39 | 82.59 | −2.25 | 47.76 | 143.5 | 8.66 | opaquer than TiO₂ |
| | | | | | | control |
| Formula 41 | 57.11 | −2.54 | 39.82 | 134 | 8.92 | — |
| Formula 42 | 60.59 | −2.62 | 43.22 | 149 | 8.81 | — |
| Formula 43 | 63.28 | −2.22 | 46.81 | 150.5 | 8.9 | — |
| Formula 44 | 66.37 | −2.1 | 49.25 | 145.5 | 8.84 | — |
| Formula 45 | 71.21 | −1.63 | 53.58 | 154 | 8.69 | — |
| Formula 47 | 53.42 | −3.19 | 34.76 | 131.5 | 8.92 | — |
| Formula 48 | 54.78 | −4.22 | 34.98 | 145.5 | 8.94 | — |
| Formula 49 | 56.23 | −2.78 | 38.05 | 136.5 | 8.88 | — |
| Formula 50 | 58.57 | −2.18 | 40.8 | 137.5 | 8.85 | — |
| Formula 51 | 62.05 | −2.58 | 42.54 | 145.5 | 8.79 | — |

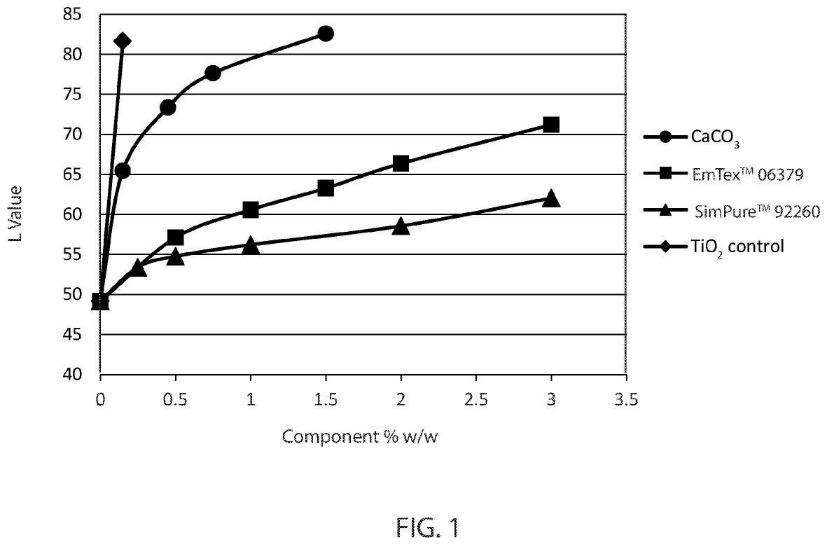

The L value colorimetry data for sample sets 1 to 3 are summarized in FIG. 1. The data show the individual impact of calcium carbonate, modified food starch (EmTex™ 06379 starch), and soluble rice flour (SimPure™ 92260) on the color of the food product. Calcium carbonate was shown to have the most significant impact on the food product color followed by the modified food starch (EmTex™ 06379 starch) and then the soluble rice flour (SimPure™ 92260), where it is noted that the rice flour had the least impact on food product color.

### Example 14: Effects of Individual Ingredients on Food Product Color

The assay described in this example investigates the effects of various combinations of components of the food colorant replacer composition on the final color a food-grade egg product. This example details the contribution of each component of the composition on the food color of the food product by looking at various combinations of calcium carbonate, EmTex™ 06379 starch, and SimPure™ 92260 soluble rice flour. The base food product formulation described in example 13 and listed in table 20 was also used in the formulations described in this example.

In Sample Set 4, the effects of 0.150% w/w calcium carbonate combined with EmTex™ 06379 starch were investigated. The calcium carbonate concentration was held constant at 0.150% w/w while the concentration of EmTex™ 06379 starch ranged from 0 w/w to 3.000% w/w. In Sample Set 5, the effects of 0.150% w/w calcium carbonate combined with SimPure™ 92260 soluble rice flour were investigated. The calcium carbonate concentration was held constant at 0.150% w/w while the concentration of SimPure™ 92260 soluble rice flour ranged from 0 w/w to 3.000% w/w. In Sample Set 6, the effects of 0.150% w/w calcium carbonate combined EmTex™ 06379 starch and SimPure™ 92260 soluble rice flour were investigated. The calcium carbonate concentration was held constant at 0.15% w/w while the concentration of EmTex™ 06379 starch ranged from 0 w/w to 3.000% w/w and the concentration of SimPure™ 92260 soluble rice flour ranged from 0 w/w to 3.000% w/w.

For Sample Set 4, the concentration of calcium carbonate was held at 0.150% w/w while the concentration of EmTex™ 06379 starch was varied to include 0.0% w/w, 0.500% w/w, 1.000% w/w, 1.500% w/w, 2.000% w/w, and 3.000% w/w. No SimPure™ 92260 soluble rice flour was included. The formulations used for Sample Set 4 are included in Table 25.

TABLE 25
Sample Set 4: Base Formulation Including Calcium Carbonate with Varying EmTex ™ 06379 Starch

| | | Formula | Formula | Formula | Formula | Formula | Formula | Formula |
|---|---|---|---|---|---|---|---|---|
| | Control | 52 | 53 | 54 | 55 | 56 | 57 | 58 |
| Ingredient | (w/w %) | (w/w %) | (w/w %) | (w/w %) | (w/w %) | (w/w %) | (w/w %) | (w/w %) |
| pasteurized | 99.325 | 99.175 | 99.175 | 98.675 | 98.175 | 97.675 | 97.175 | 96.175 |
| egg whites | | | | | | | | |
| soybean | 0.500 | 0.500 | 0.500 | 0.500 | 0.500 | 0.500 | 0.500 | 0.500 |
| oil | | | | | | | | |
| xanthan | 0.150 | 0.150 | 0.150 | 0.150 | 0.150 | 0.150 | 0.150 | 0.150 |
| gum | | | | | | | | |
| beta- | 0.025 | 0.025 | 0.025 | 0.025 | 0.025 | 0.025 | 0.025 | 0.025 |
| carotene | | | | | | | | |
| titanium | 0.000 | 0.150 | 0 | 0 | 0 | 0 | 0 | 0 |
| dioxide | | | | | | | | |
| calcium | 0 | 0 | 0.150 | 0.150 | 0.150 | 0.150 | 0.150 | 0.150 |
| carbonate | | | | | | | | |
| EmTex ™ | 0 | 0 | 0 | 0.500 | 1.000 | 1.500 | 2.000 | 3.000 |
| 06379 | | | | | | | | |
| starch | | | | | | | | |
| SimPure ™ | 0 | 0 | 0 | 0 | 0 | 0 | 0 | 0 |
| 92260 | | | | | | | | |

For Sample Set 5, the concentration of calcium carbonate was held at 0.150% w/w while the concentration of SimPure™ 92260 soluble rice flour was varied to include 0.0% w/w, 0.250% w/w, 0.500% w/w, 1.000% w/w, 1.500% w/w, 2.000% w/w, and 3.000% w/w. No EmTex™ 06379 starch was included. The formulations used for Sample Set 5 are included in Table 26.

TABLE 26
Sample Set 5: Base Formulation Including Calcium
Carbonate with Varying SimPure™ 92260 Soluble Rice Flour

| | Formula | Formula | Formula | Formula | Formula |
|---|---|---|---|---|---|
| | 59 | 60 | 61 | 62 | 63 |
| Ingredient | (w/w %) | (w/w %) | (w/w %) | (w/w %) | (w/w %) |
| pasteurized | 98.925 | 98.675 | 98.175 | 97.175 | 96.175 |
| egg whites | | | | | |
| soybean | 0.500 | 0.500 | 0.500 | 0.500 | 0.500 |
| oil | | | | | |
| xanthan | 0.150 | 0.150 | 0.150 | 0.150 | 0.150 |
| gum | | | | | |
| beta- | 0.025 | 0.025 | 0.025 | 0.025 | 0.025 |
| carotene | | | | | |
| titanium | 0 | 0 | 0 | 0 | 0 |
| dioxide | | | | | |
| calcium | 0.150 | 0.150 | 0.150 | 0.150 | 0.150 |
| carbonate | | | | | |
| EmTex™ | 0 | 0 | 0 | 0 | 0 |
| 06379 | | | | | |
| starch | | | | | |
| SimPure™ | 0.250 | 0.500 | 1.000 | 2.000 | 3.000 |
| 92260 | | | | | |

For Sample Set 6, the concentration of calcium carbonate was held at 0.150% w/w while the concentration of EmTex™ 06379 starch and SimPure™ 92260 soluble rice flour were varied. The concentrations of EmTex™ 06379 starch included 1.000% w/w, 1.500% w/w, or 2.000% w/w, while the concentrations of SimPure™ 92260 soluble rice flour included 0.250% w/w, 0.500% w/w, or 1.000% w/w. The formulations used for Sample Set 6 are included in Table 27.

TABLE 27
Sample Set 6: Base Formulation Including Calcium Carbonate with Varying EmTex ™ 06379
Starch and SimPure ™ 92260 Soluble Rice Flour

| | Formula | Formula | Formula | Formula | Formula | Formula | Formula | Formula | Formula |
|---|---|---|---|---|---|---|---|---|---|
| | 64 | 65 | 66 | 67 | 68 | 79 | 70 | 71 | 72 |
| Ingredient | (w/w %) | (w/w %) | (w/w %) | (w/w %) | (w/w %) | (w/w %) | (w/w %) | (w/w %) | (w/w %) |
| pasteurized | 97.925 | 97.675 | 97.425 | 97.175 | 96.925 | 96.675 | 97.175 | 96.675 | 96.175 |
| egg whites | | | | | | | | | |
| soybean oil | 0.500 | 0.500 | 0.500 | 0.500 | 0.500 | 0.500 | 0.500 | 0.500 | 0.500 |
| xanthan | 0.150 | 0.150 | 0.150 | 0.150 | 0.150 | 0.150 | 0.150 | 0.150 | 0.150 |
| gum | | | | | | | | | |
| beta- | 0.025 | 0.025 | 0.025 | 0.025 | 0.025 | 0.025 | 0.025 | 0.025 | 0.025 |
| carotene | | | | | | | | | |
| titanium | 0 | 0 | 0 | 0 | 0 | 0 | 0 | 0 | 0 |
| dioxide | | | | | | | | | |
| calcium | 0.150 | 0.150 | 0.150 | 0.150 | 0.150 | 0.150 | 0.150 | 0.150 | 0.150 |
| carbonate | | | | | | | | | |
| EmTex ™ | 1.000 | 1.000 | 1.500 | 1.500 | 2.000 | 2.000 | 1.000 | 1.500 | 2.000 |
| 06379 | | | | | | | | | |
| starch | | | | | | | | | |
| SimPure ™ | 0.250 | 0.500 | 0.250 | 0.500 | 0.250 | 0.500 | 1.000 | 1.000 | 1.000 |
| 92260 | | | | | | | | | |

Color and viscosity data for each formulation (uncooked) detailed for Sample Sets 4 to 6 are reported in Table 28.

TABLE 28
Colorimetry Data for Formulations 52-72

| | Colorimetry Data | | |
|---|---|---|---|
| Formula | L | a | b |
| Control | 58.59 | −4.59 | 36.2 |
| Formula 52 | 80.66 | −2 | 48.74 |
| Formula 53 | 66.86 | −2.44 | 47.07 |
| Formula 54 | 68.53 | −3.26 | 46.51 |
| Formula 55 | 70.04 | −3.1 | 47.58 |
| Formula 56 | 71.85 | −2.48 | 49.95 |
| Formula 57 | 72.93 | −2.68 | 49.53 |
| Formula 58 | 74.53 | −2.58 | 50.1 |
| Formula 59 | 67.5 | −3.35 | 45.37 |
| Formula 60 | 67.56 | −3.54 | 44.98 |
| Formula 61 | 68.02 | −2.86 | 45.48 |
| Formula 62 | 69.29 | −1.95 | 47.05 |
| Formula 63 | 70.33 | −1.9 | 47.18 |
| Formula 64 | 70.14 | −2.71 | 48.16 |
| Formula 65 | 71.07 | −2.64 | 48.35 |
| Formula 66 | 72.12 | −2.86 | 48.59 |
| Formula 67 | 72.06 | −2.46 | 49.24 |
| Formula 68 | 73.01 | −2.5 | 49.61 |
| Formula 69 | 72.82 | −2.91 | 48.61 |
| Formula 70 | 71.83 | −2.06 | 49.12 |
| Formula 71 | 72.18 | −2.23 | 49.11 |
| Formula 72 | 73.28 | −2.09 | 49.57 |

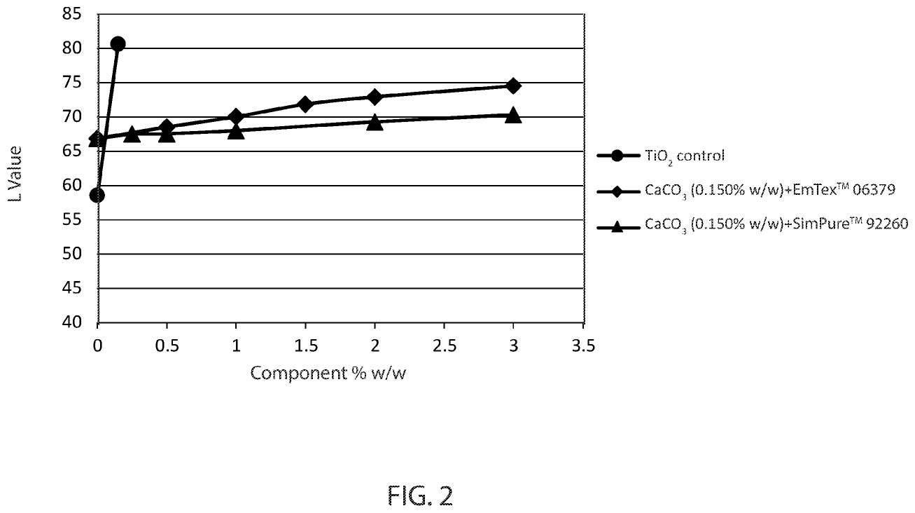

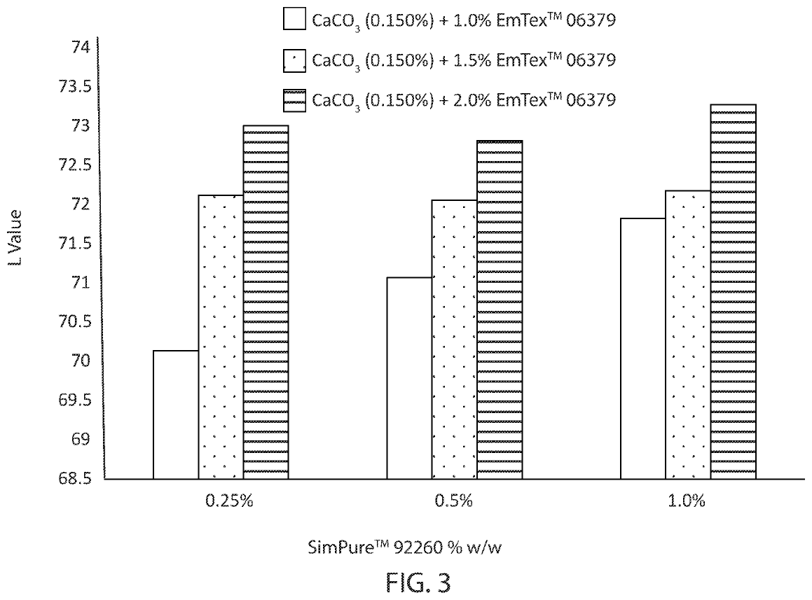

The L value colorimetry data for sample sets 4 and 5 are summarized in FIG. 2. The data show the impact of modified food starch (EmTex™ 06379 starch) and soluble rice flour (SimPure™ 92260) when the concentration of calcium carbonate is held at a constant concentration of 0.015% w/w on the color of the food product. Calcium carbonate increased the color impact on the control and followed similar trends to the data shown in FIG. 1 where it was shown to have the most significant impact on the food product color followed by the modified food starch (EmTex™ 06379 starch) and then the soluble rice flour (SimPure™ 92260). The L value colorimetry data for sample set 6 is summarized in FIG. 3.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference is to be considered supplementary to that of this document; for irreconcilable inconsistencies, the usage in this document controls.

Values expressed in a range format are to be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” is to be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis (w/w %) is used interchangeably with weight percent (wt. %) or percent by weight (% wt.) herein.

1. A food colorant replacer composition comprising:
from 0.5 wt. % to 2.5 wt. % modified food starch obtained by n-octenyl succinic anhydride esterification of starch isolated from waxy maize;
from 0.10 wt. % to 2.0 wt. % soluble rice flour obtained by enzymatic treatment of rice flour; and
from 0.10 wt. % to 0.76 wt. % calcium carbonate.

2. The composition of claim 1, wherein the modified food starch comprises:
i. hydrophilic and lipophilic properties;
ii. a pH of from 5.0 to 7.0 when mixed as a 20% w/w aqueous solution; and
iii. a moisture content of from 10.5% to 12.5%.

3. The composition of claim 1, wherein the modified food starch has not been subjected to a thinning process.

4. The composition of claim 1, wherein the modified food starch comprises a granular starch.

5. The composition of claim 1, wherein the soluble rice flour has not been subjected to a further enzymatic reaction or a filtering process.

6. The composition of claim 1, wherein the soluble rice flour comprises:
i. a dextrose equivalent of from 8 to 15;
ii. a solubility greater than 50% at 5% solids; and
iii. a viscosity 1 centipoise to 1000 centipoise at temperatures ranging from 20° C. to 50° C. at 10% solids.

7. The composition of claim 1, wherein the soluble rice flour comprises:
a soluble component that is from about 80-95 wt. % soluble in water; and
an insoluble component from about 0-20 wt. % and that imparts at least a portion of a whitening effect by the food colorant replacer composition; and
wherein the rice flour does not confer an increase in viscosity to the food colorant replacer composition.

8. The composition of claim 1, wherein the calcium carbonate comprises from 0.10 to 0.15 wt. %.

9. (canceled)

10. The composition of claim 1, wherein the food colorant replacer composition has an L value or imparts an L value in a food product that is from 75 to 90.

11. The composition of claim 1, wherein the food colorant replacer composition comprises a powder composition.

12. The composition of claim 1, wherein the food colorant replacer composition comprises a colloidal dispersion or an aqueous suspension.

13. A food product comprising a food colorant replacer composition of claim 1.

14. (canceled)

15. The food product composition of claim 13, wherein the food product is free of titanium dioxide.

16. A method for producing a food colorant replacer composition for use in food-grade products comprising:
(a) providing a modified food starch, wherein the modified food starch is obtained by n-octenyl succinic anhydride esterification of starch isolated from waxy maize;
(b) providing a soluble rice flour, wherein the soluble rice flour is obtained by enzymatic treatment of rice flour and is not subjected to any additional filtering or purification processes;
(c) providing calcium carbonate; and
(d) mixing the modified food starch, the soluble rice flour, and the calcium carbonate to form the food colorant replacer composition; and
wherein the food colorant replacer composition is suitable for use in the food-grade products to impart a whitening effect to the food-grade product at concentrations comprising:
from 0.50 wt. % to 2.5 wt. % of the modified food starch;
from 0.10 wt. % to 2.0 wt. % of the soluble rice flour; and
from 0.10 wt. % to 0.76 wt. % of calcium carbonate.

17. The method of claim 16, wherein the modified food starch comprises:
i. hydrophilic and lipophilic properties;
ii. a pH of from 5.0 to 7.0 when mixed as a 20% w/w aqueous solution; and
iii. a moisture content of from 10.5% to 12.5%.

18. The method of claim 16, wherein the modified food starch has not been subjected to a thinning process.

19. The method of claim 16, wherein the modified food starch comprises a granular starch.

20. The method of claim 16, wherein the soluble rice flour comprises:
i. a dextrose equivalent of from 8 to 15;
ii. a solubility greater than 50% at 5% solids; and
iii. a viscosity 1 centipoise to 1000 centipoise at temperatures ranging from 20° C. to 50° C. at 10% solids.

21. The method of claim 16, wherein the soluble rice flour comprises:
a soluble component that is from about 80-95 wt. % soluble in water; and
an insoluble component from about 0-20 wt. % and that imparts at least a portion of a whitening effect by the food colorant replacer composition; and
wherein the rice flour does not confer an increase in viscosity to the food colorant replacer composition.

22. (canceled)

23. The method of claim 16, further comprising analyzing L, a, and b color values of the food colorant replacer composition; and
modifying one or more concentrations of the modified food starch, the soluble rice flour, or the calcium carbonate to adjust one or more of the L, a, or b color values to within predetermined values.

24. (canceled)
